(19) United States
(12) Patent Application Publication
(10) Pub. No.: US 2024/0311878 A1
(43) Pub. Date: Sep. 19, 2024

(54) REAL-TIME SPEECH AND PRESENTATION ASSISTANCE IN A VIRTUAL ENVIRONMENT

(71) Applicant: INTERNATIONAL BUSINESS MACHINES CORPORATION, Armonk, NY (US)

(72) Inventors: Jeremy R. Fox, Georgetown, TX (US); Jessica Nahulan, Markham (CA); Tiberiu Suto, Franklin, NY (US); Carolina Garcia Delgado, Zapopan (MX)

(21) Appl. No.: 18/122,260

(22) Filed: Mar. 16, 2023

(51) Int. Cl. G06Q 30/0282

(52) U.S. Cl. CPC G06Q 30/0282; G06F 3/011

(57) ABSTRACT

A method for automatically generating and displaying real-time virtual feedback to a presenter in a virtual environment corresponding to a user experience associated with a target audience in the virtual environment is provided. The method may include automatically identifying participants in the virtual environment. The method may further include, automatically detecting and tracking one or more user actions and reactions associated with the participants in the virtual event to identify real-time participant feedback associated with each of the participants based on the virtual event, wherein identifying the real-time participant feedback further comprises determining a correlation between the real-time participant feedback associated with the target audience with the real-time participant feedback associated with the presenter. The method may further include automatically generating and displaying to the presenter a real-time assessment of the virtual event based on the determined correlation and the real-time participant feedback.

### BACKGROUND

The present invention relates generally to the field of computing, and more specifically, to providing real-time virtual feedback and assistance to users/presenters in a virtual environment based on detected interactions between the presenter and a target audience in the virtual environment.

Generally, virtual environments/worlds have become popular spaces for individuals to conduct virtual interactions including conferences, presentations, and other public and group experiences using technology such as virtual and/or augmented reality. Specifically, virtual reality (VR) may be characterized as a persistent virtual world that may continue to exist even when a user is not present, for example, when a user is not logged into the virtual world. Virtual environments/worlds may also include augmented reality (AR) that may also combine aspects of both digital and physical worlds. However, virtual environments do not require that such virtual spaces be exclusively accessed via VR or AR. For example, video games having virtual environments can be accessed through personal computers (PCs), game consoles, and even mobile phones. An emerging representation of a virtual environment/world may commonly be referred to as a metaverse. A metaverse may be characterized as an iteration of a virtual environment that may use the Internet and/or other software tools to generate a universal and immersive virtual space that may be facilitated by hardware such as VR and AR headsets. The metaverse may include a network of 3D virtual worlds which may focus on social connection. For example, a metaverse experience may include a presenter who is presenting and speaking with avatars of other metaverse attendees representing the target audience.

### SUMMARY

A method for automatically generating and displaying real-time virtual feedback to a presenter in a virtual environment corresponding to a user experience associated with a target audience in the virtual environment is provided. The method may include, in response to initiating and detecting a virtual event, automatically identifying participants in the virtual environment associated with the virtual event, wherein identifying the participants further comprises identifying the presenter and the target audience. The method may further include, automatically detecting and tracking one or more user actions and user reactions associated with each of the one or more participants in the virtual event to identify real-time participant feedback associated with each of the one or more participants based on the virtual event, wherein identifying the real-time participant feedback further comprises determining a correlation between the real-time participant feedback associated with the one or more participants of the target audience with the real-time participant feedback associated with the presenter. The method may further include automatically generating and displaying to the presenter a real-time assessment of the virtual event based on the determined correlation and the real-time participant feedback associated with the target audience, wherein the real-time assessment further includes generating and displaying on the virtual environment visual prompts representing scaled user reactions from the target audience and generating and displaying suggestions for improving the scaled user reactions.

A computer system for automatically generating and displaying real-time virtual feedback to a presenter in a virtual environment corresponding to a user experience associated with a target audience in the virtual environment is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include, in response to initiating and detecting a virtual event, automatically identifying participants in the virtual environment associated with the virtual event, wherein identifying the participants further comprises identifying the presenter and the target audience. The method may further include, automatically detecting and tracking one or more user actions and user reactions associated with each of the one or more participants in the virtual event to identify real-time participant feedback associated with each of the one or more participants based on the virtual event, wherein identifying the real-time participant feedback further comprises determining a correlation between the real-time participant feedback associated with the one or more participants of the target audience with the real-time participant feedback associated with the presenter. The method may further include automatically generating and displaying to the presenter a real-time assessment of the virtual event based on the determined correlation and the real-time participant feedback associated with the target audience, wherein the real-time assessment further includes generating and displaying on the virtual environment visual prompts representing scaled user reactions from the target audience and generating and displaying suggestions for improving the scaled user reactions.

A computer program product for automatically generating and displaying real-time virtual feedback to a presenter in a virtual environment corresponding to a user experience associated with a target audience in the virtual environment is provided. The computer program product may include one or more computer-readable storage devices and program instructions stored on at least one of the one or more tangible storage devices, the program instructions executable by a processor. The computer program product may include program instructions to, in response to initiating and detecting a virtual event, automatically identify participants in the virtual environment associated with the virtual event, wherein identifying the participants further comprises identifying the presenter and the target audience. The computer program product may further include program instructions to automatically detect and track one or more user actions and user reactions associated with each of the one or more participants in the virtual event to identify real-time participant feedback associated with each of the one or more participants based on the virtual event, wherein identifying the real-time participant feedback further comprises determining a correlation between the real-time participant feedback associated with the one or more participants of the target audience with the real-time participant feedback associated with the presenter. The computer program product may include program instructions to automatically generate and display to the presenter a real-time assessment of the virtual event based on the determined correlation and the real-time participant feedback associated with the target audience, wherein the real-time assessment further includes generating and displaying on the virtual environment visual prompts representing scaled user reactions from the target audience and generating and displaying suggestions for improving the scaled user reactions.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computing environment according to one embodiment;

FIG. 2 is an example virtual environment associated with a virtual event corresponding to a program for automatically generating and displaying real-time virtual feedback to a presenter in a virtual environment corresponding to a user experience associated with a target audience in the virtual environment according to one embodiment;

FIG. 3 is an operational flowchart for automatically generating and displaying real-time virtual feedback to a presenter in a virtual environment corresponding to the user experience associated with the target audience in the virtual environment according to one embodiment;

FIG. 4 is an example of visual prompts including graphical user interface (GUI) icons for representing a level of sound and a level of attention associated with participants and/or groups of participants of the target audience according to one embodiment;

FIG. 5 is an example participant feedback chart associated with the program for automatically generating and displaying real-time virtual feedback to a presenter in a virtual environment corresponding to a user experience associated with a target audience in the virtual environment according to one embodiment;

FIG. 6 is the virtual environment including a real-time assessment displayed and overlaid on the virtual environment and over participants of the target audience according to one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate generally to the field of computing, and more particularly, to automatically providing real-time virtual feedback and assistance to users/presenters in a virtual environment based on detected user engagement and other factors from members of a target audience and the presenter in the virtual environment. Specifically, the present invention may improve the technical field associated with virtual environments, including virtual events and virtual conferencing, by automatically and dynamically tracking and providing real-time feedback and interface prompts to a user/presenter as the user/presenter speaks to a target audience in the virtual environment. For example, the present invention may leverage crowdsourced information from the target virtual audience to detect real-time audience feedback and present the crowdsourced information to the presenter, whereby the crowdsourced information may be utilized to improve an outcome of a presentation. More specifically, utilizing the crowdsourced information, the present invention may identify common audience experienced issues when listening to the presenter at various stages of a presentation in the virtual environment. As such, responsive to identifying the audience experienced issues, such as important information of the presentation being missed by key members of the audience, the present invention may provide the presenter (for example, on a virtual display) exactly which parts of the presentation were not received by the key members as well as provide other information and resolutions to improve the presentation and remedy the audience experienced issues.

As previously described, virtual environments/worlds have become popular spaces for individuals to conduct virtual interactions including conferences, presentations, and other public and group experiences. For example, a virtual environment may use computing technology such as the Internet and/or other software tools to generate a universal and immersive virtual space that may also be facilitated by hardware tools such as VR and AR headsets. As such, a virtual environment may include a network of 3D virtual worlds that may mimic real-life social connections and experiences using such computing technology. For example, a virtual event may include a virtual conference conducted in the virtual environment. The virtual event may include a presenter represented by a virtual avatar who is presenting and speaking with other virtual avatars representative of the audience/attendees in the virtual environment. Using the previously mentioned computing technology, including the Internet, other software tools, and VR/AR headsets, the virtual environment may mimic a real-life conference such that factors including level of sound of the presenter and attendees, position of the audience in the virtual environment, level of participation and engagement of the audience, and gestures by the presenter may play a role in the presentation. For example, common challenges/questions from the presenter side may include: can the audience at the back of the virtual environment see the presenter, can the audience hear the presenter well, can the audience see the presenter's hand gestures, is the presenter paying enough attention and giving eye contact to certain members and sections of the audience on different sides of the room.

Therefore, it may be advantageous, among other things, to provide a method, computer system, and computer program product for automatically displaying real-time virtual feedback to a presenter in a virtual environment corresponding to a user experience associated with a target audience in the virtual environment. Specifically, the method, computer system, and computer program product may, in response to initiating and detecting a virtual event, automatically identify participants in the virtual environment associated with the virtual event, wherein identifying the participants further comprises identifying the presenter and the target audience. Then, the method, computer system, and computer program product may automatically detect and track one or more user actions and user reactions associated with each of the one or more participants in the virtual event to identify real-time participant feedback associated with each of the one or more participants based on the virtual event, wherein identifying the real-time participant feedback further comprises determining a correlation between the real-time participant feedback associated with the one or more participants of the target audience with the real-time participant feedback associated with the presenter. Next, the method, computer system, and computer program product may automatically generate and display to the presenter a real-time assessment of the virtual event based on the determined correlation and the real-time participant feedback associated with the target audience, wherein the real-time assessment further includes generating and displaying on the virtual environment visual prompts representing scaled user reactions from the target audience and generating and displaying suggestions for improving the scaled user reactions.

The present invention may be a system, a method, and/or a computer program product at any possible technical detail level of integration. The computer program product may include a computer readable storage medium (or media) having computer readable program instructions thereon for causing a processor to carry out aspects of the present invention.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to determine whether directional input is received along with a query and. accordingly, adjust presented display content to include a referenced object in a center of a screen of a primary device.

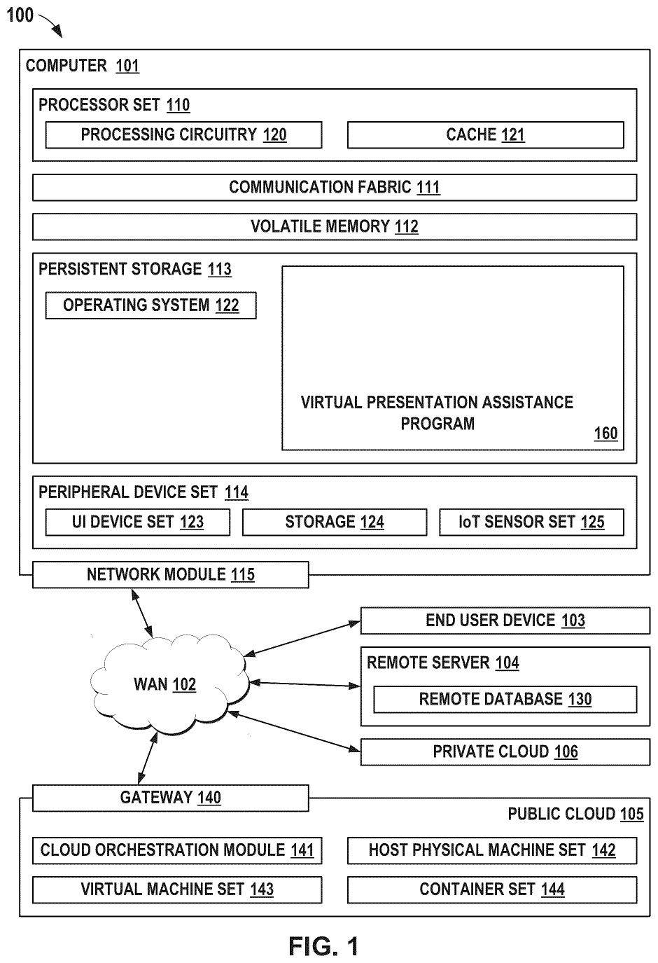

Referring to FIG. 1, an exemplary computing environment 100 is depicted, according to at least one embodiment. Computing environment 100 contains an example of an environment for the execution of at least some of the computer code involved in performing the inventive methods, such as a virtual presentation assistance program 160. In addition to block 160, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 160, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer (such as a wearable headset), mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 160 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 160 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles, headsets, and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector and/or accelerometer.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the virtual presentation assistance program 160 may be a program/code capable of automatically displaying real-time virtual feedback to a presenter in a virtual environment corresponding to a user experience associated with a target audience in the virtual environment. Specifically, the virtual presentation assistance program 160 may, in response to initiating and detecting a virtual event, automatically identify participants in the virtual environment associated with the virtual event, wherein identifying the participants further comprises identifying the presenter and the target audience. Then, the virtual presentation assistance program 160 may automatically detect and track one or more user actions and user reactions associated with each of the one or more participants in the virtual event to identify real-time participant feedback associated with each of the one or more participants based on the virtual event, wherein identifying the real-time participant feedback further comprises determining a correlation between the real-time participant feedback associated with the one or more participants of the target audience with the real-time participant feedback associated with the presenter. Next, the virtual presentation assistance program 160 may automatically generate and display to the presenter a real-time assessment of the virtual event based on the determined correlation and the real-time participant feedback associated with the target audience, wherein the real-time assessment further includes generating and displaying on the virtual environment visual prompts representing scaled user reactions from the target audience and generating and displaying suggestions for improving the scaled user reactions.

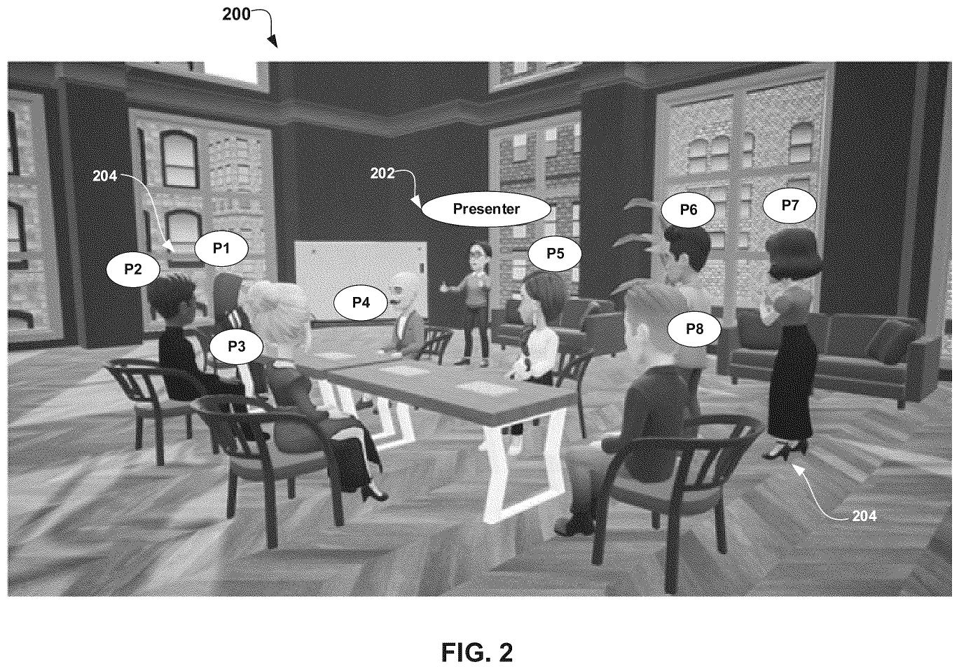

Furthermore, notwithstanding depiction in computer 101, the virtual presentation assistance program 160 may be stored in and/or executed by, individually or in any combination, end user device 103, remote server 104, public cloud 105, and private cloud 106. The virtual presentation assistance program is explained in further detail below with respect to FIGS. 2, 3, and 4.

Referring now to FIG. 2, an example virtual environment 200 associated with virtual event corresponding to the virtual presentation assistance program 160 is depicted. According to one embodiment, the virtual environment 200 may include users virtually participating in a virtual event such as a virtual conference/presentation. As previously described, a virtual environment 200 may be accessed by a user via a computing device such as wearable device including a virtual reality (VR) headset. As previously described, virtual environments can also be accessed through personal computers (PCs), game consoles, and even mobile phones. Thus, a user may, for example, access the virtual environment via a computer 101 (FIG. 1) by logging into the virtual environment using user login credentials.

According to one embodiment, the virtual presentation assistance program 160 may also include an opt-in feature where users have to agree to an opt-in agreement via a user interface presented during a registration process by a user for registering with the virtual presentation assistance program 160 and/or at log-in to enter a virtual conference room, i.e. the virtual environment 200. According to one embodiment, the opt-in feature may enable users to grant the virtual presentation assistance program 160 the ability to gather and access user profile data. For example, the user profile data may include, but is not limited to, data associated with user preferences (including likes and dislikes of certain subjects or subject matter, which may be gathered via surveys or questionnaires presented via the user interface to a user at registration), user equipment data (such as information associated with a computer 101, including a VR headset), user movement/gesture data detected using the user equipment, and user information related to a user title and/or a position within a company/employment.

According to one embodiment, the opt-in feature may also allow users to grant the virtual presentation assistance program 160 the ability to track user actions and reactions of the user to be utilized for providing real-time virtual feedback to a presenter, whereby the opt-in feature may grant the virtual presentation assistance program 160 access to a user's/participant's computing device (again, such as the VR headset/goggles) including camera, sensors, speaker and microphone. As depicted in FIG. 2, the virtual event may be a virtual conference where users/participants use avatars to depict the user's presence in the virtual event. As previously described, a virtual environment 200 may include 3D virtual worlds that may mimic real-life social connections and experiences using computing technology. As such, the virtual event may be a virtual conference including a presenter 202 represented by a virtual avatar who is presenting and speaking with other virtual avatars representative of the target audience/attendees 204 in the virtual environment 200. Using previously mentioned computing technology. including the Internet, other software tools, and computing devices such as VR/AR headsets, the virtual environment 200 may mimic a real-life conference such that factors including a level of sound associated with the presenter 202 as well as the target audience 204, position of the presenter 202 and a member of the target audience 204 in the virtual environment 200, whether a member of the target audience 204 is able to view the presenter 202, a level of participation and engagement of members of the target audience 204, and gestures made by the presenter 202 may all play a role in the presentation and real-time feedback from the target audience 204.

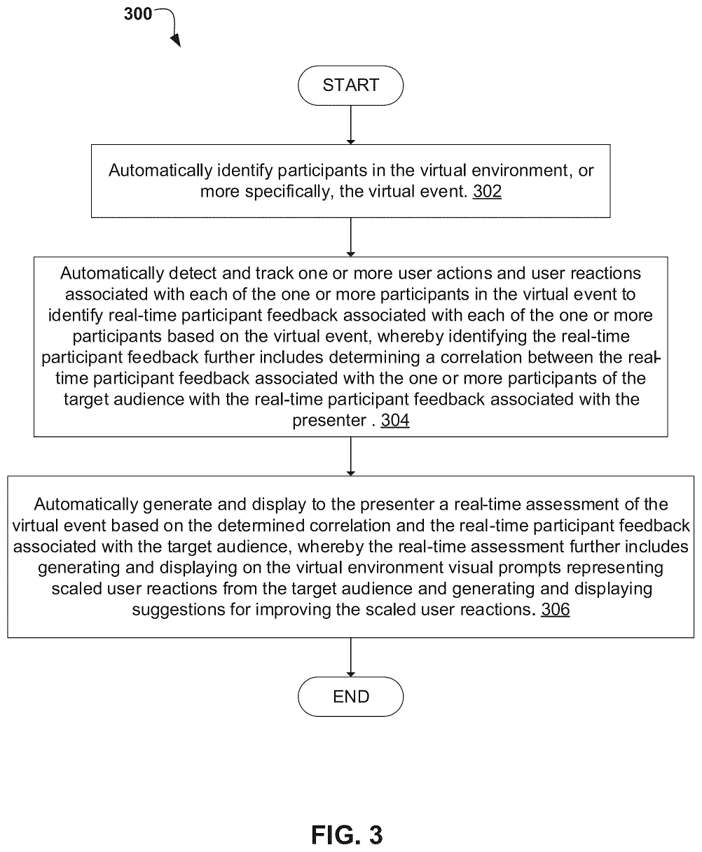

As such, an operational flowchart 300 is depicted in FIG. 3 for automatically generating and displaying real-time virtual feedback to a presenter 202 in a virtual environment 200 corresponding to a user experience associated with a target audience 204 in the virtual environment 200. Specifically, and as depicted at 302, in response to initiating and/or detecting the virtual event (which, again, may be displayed via a computer 101 such as on a display associated with a VR headset/goggles), the virtual presentation assistance program 160 may automatically identify participants in the virtual environment, or more specifically, the virtual event. Specifically, for example, the virtual presentation assistance program 160 may automatically identify one or more presenters 202 and the target audience 204. For example, according to one embodiment, the virtual presentation assistance program 160 may identify the presenter 202 (or multiple presenters) by including a feature, such as a tag or label, to allow the virtual presentation program 160 and/or a host of the virtual event (via a user interface) to designate users/participants as presenters, whereby the virtual presentation assistance program 160 may automatically identify all other users/participants not tagged as the presenter as the target audience. As such, for example and referring back to FIG. 2, the virtual presentation assistance program 160 may display a label such as “presenter” 202 as well as display other labels identifying the target audience 204, which may include participants P1, P2, P3, P4, P5, P6, P7, and P8.

In addition to automatically identifying whether a participant is a presenter 202 and/or part of the target audience 204, the virtual presentation assistance program 160 may also detect and access user profile data associated with the participants. As previously described with respect to FIG. 2, the virtual presentation assistance program 160 may gather and access user profile data whereby the user profile data may, for example, include data associated with user preferences (including likes and dislikes regarding certain subject matter, user equipment data (such as information associated with a computer and/or VR headset), user movement/gesture data detected using the user equipment, and user information related to a user title and/or a position within a company/employment.

According to one embodiment, the virtual presentation assistance program 160 may also automatically identify whether participants in the virtual environment 200 are key audience members. Specifically, for example, the virtual presentation assistance program 160 may further allow a user to identify certain key audience members of a target audience either during a registration process, before entering/launching the virtual event, at log-in into the virtual environment/event, and/or during the virtual event. For example, because of a certain importance, a user/presenter may consider a boss a key audience member and/or may consider other colleagues/friends that are important or have a certain expertise related to a discussion that the user may be presenting in the virtual event as key audience members. As such, according to one embodiment, the virtual presentation assistance program 160 may present the user with a user interface whereby a user may select individuals as key audience members during a registration process, before entering/launching the virtual event, at log-in into the virtual environment/event, and/or during the virtual event.

Also, according to one embodiment, the virtual presentation assistance program 160 may automatically identify key audience members of the target audience based, for example, on a title associated with a user/participant and/or based on credentials associated with the user/participant. More specifically, for example, the virtual presentation assistance program 160 may access and leverage an electronic employee directory, organizational chart, friend groups, social media and/or other information available via a network and/or the internet to further identify information associated with an employer, employees (including an employee hierarchy), colleagues, friends, and other participants. In turn, the virtual presentation assistance program 160 may use natural language processing and machine learning algorithms to identify a boss, identify experts on certain subject matter based on credentials, and/or identify close friends to automatically identify whether a participant in a virtual event is a key audience member. According to one embodiment, and as will be further described, in response to identifying a key audience member in the virtual event, the virtual presentation assistance program 160 may be triggered to focus certain aspects of the real-time presentation feedback on the key audience member. Therefore, while the presenter may be presenting to all participants of a target audience 204, the presenter may want more focus and feedback on the key audience members of the target audience because those key audience members may be of greater importance to the presenter with regard to a virtual presentation.

Next, at 304, the virtual presentation assistance program 160 may automatically detect and track one or more user actions and user reactions associated with each of the one or more participants in the virtual event to identify real-time participant feedback associated with each of the one or more participants based on the virtual event, whereby identifying the real-time participant feedback further includes determining a correlation between the real-time participant feedback associated with the one or more participants of the target audience with the real-time participant feedback associated with the presenter. Specifically, the virtual presentation assistance program 160 may automatically detect and track one or more user actions and reactions associated with each of the one or more participants based on movements and communications detected using the computer and the virtual avatars of each of the one or more participants to determine the correlation, whereby determining the correlation may further include detecting and tracking the one or more user actions and reactions based on the presentation made by the presenter in the virtual event.

More specifically, according to one embodiment, the virtual presentation assistance program 160 may detect and track one or more user actions and user reactions associated with members of the target audience as well as with presenters. Furthermore, according to one embodiment, the virtual presentation assistance program 160 may detect and track the one or more user actions and user reactions differently for participants based on whether a participant is a presenter or a member of the target audience. Additionally, and as previously described, the virtual presentation assistance program 160 may detect and track user actions and user reactions differently for key audience members.

Specifically, for members of the target audience in the virtual event, the virtual presentation assistance program 160 may automatically detect and track one or more user actions and user reactions associated with participants of the target audience to identify real-time participant feedback by, for example, detecting and correlating a participant's level of sound and level of attention with regard to the presenter and/or a presentation made by the presenter. More particularly, for the participants identified as the target audience, the virtual presentation assistance program 160 may track a level of sound received by a participant based on the computing device (computer, mobile device, VR headset, and/or other ways the participant is accessing the virtual event) and the virtual avatar corresponding to a member of the target audience to determine, for example, whether the member of the target audience is able to hear the presenter clearly during a presentation and/or part of a presentation of the presenter. According to one embodiment, the virtual presentation assistance program 160 may determine the level of sound by, for example, accessing and leveraging the speakers and microphones associated with the computer of the users/participants to determine whether there are any disruptions/distortions in sound and/or other noise factors (such as noise and/or ambient sound coming from other nearby participants and/or others outside of the virtual environment 200) that may be causing the member of the target audience to not hear the presentation and/or certain parts of the presentation. The virtual presentation assistance program 160 may also determine the level of sound by, for example, leveraging the microphones associated with a user's/participant's computer to receive feedback including speech/voice from the user to determine whether the user is unable to hear the presenter or parts of the presentation, and/or is in some other way dissatisfied with the presentation.

For example, using the speakers and microphones associated with the computers of the participants (P1, P2, P3, P4, P5, P6, P7, and P8), the virtual presentation assistance program 160 may determine that a member of the audience (P5) is experiencing difficulty hearing the presenter 202 based on detecting, tracking, and correlating (via the participant's microphone and/or speakers) certain user actions and user reactions including sound from a conversation between other nearby members of the target audience (P6 and P7) which may be overshadowing/distorting the sound from the presenter 202. Specifically, and using the depicting in FIG. 2, the virtual presentation assistance program 160 may detect that the member's (P5) microphone and/or speakers may be receiving more sound (or a higher level of sound, which may be measured by the virtual presentation assistance program 160 based on amplitude values or decibel units) from the conversation of nearby participants (P6 and P7) than from the presenter 202. More specifically, using the participant's microphone and/or speakers, the virtual presentation assistance program 160 may detect that measured decibel units coming into the speakers of the member (P5) from the speech/conversation between other nearby members of the target audience (P6 and P7) may be more than the speech decibel units coming from the presenter 202. According to one embodiment, the virtual presentation assistance program 160 may also detect the member (P5) stating, “I couldn't hear that last part,” which may also indicate to the virtual presentation assistance program 160 that the member (P5) is having difficulty hearing the presenter and/or a part of the presentation.

Additionally, according to one embodiment, the virtual presentation assistance program 160 may track and correlate the level of sound with the virtual environment 200 itself and/or, more specifically, with a position of a participant in the target audience with respect to a position of a presenter in the virtual environment. Specifically, and as previously described, the virtual environment 200 may mimic a real-life conference such that factors including level of sound of the presenter and attendees, as well as the position of the audience in the virtual environment 200 may play a role in the presentation. For example, and as previously described, common challenges/questions may include: can the audience at the back of the virtual environment 200 hear the presenter, or is the presenter paying enough attention and giving eye contact to certain participants and/or sections of the target audience on different sides of the room. As such, the virtual presentation assistance program 160 may track the level of sound received by a participant of the target audience based on a position of the participant of the target audience in reference to the position of the presenter. More specifically, according to one embodiment, the virtual presentation assistance program 160 may again use the speakers and/or microphone associated with a participant of a target audience, as well as the virtual environment 200 itself (i.e. positions of participants and objects in a virtual space of the virtual environment 200) to continuously and dynamically measure and correlate the amplitude and/or decibel units associated with the level of sound received from the presenter based on a recorded position of the presenter. For example, according to one embodiment, the virtual presentation assistance program 160 may detect the participant (P5) stating, “I can't hear the presenter from over here,” when the presenter is positioned in a specific part of the virtual space, which may indicate to the virtual presentation assistance program 160 that the member (P5) is having difficulty hearing the presenter and/or a part of the presentation and may, in turn, trigger the virtual presentation assistance program 160 to detect and record a position of the presenter in the virtual space as well as measure the decibel units of sound received from the presenter and by the participant of the target audience based on the recorded position of the presenter.

Furthermore, for the participants identified as the target audience, the virtual presentation assistance program 160 may track a level of attention associated with a participant of the target audience based on the computing device and avatar corresponding to the participant of the target audience to determine, for example, whether the participant of the target audience is paying attention to the presenter during a presentation and/or part of a presentation of the presenter. According to one embodiment, the virtual presentation assistance program 160 may track a level of attention based on detected user actions and user reactions that may include detected gestures, movements, and facial expressions of a user/avatar. As previously described, the virtual presentation assistance program 160 may access a user's/participant's computing device (again, such as a computer including a mobile phone, VR headset/goggles, PC, and other computing devices used to access the virtual event) and the computing device may further include a camera, sensors, speaker and microphone. Furthermore, according to one embodiment, the virtual presentation assistance program 160 may include natural language processing algorithms, machine learning algorithms, facial recognition software, key tracking software, haptic feedback tracking, motion/gesture tracking, and other algorithms and software to further detect movement, gestures, speech and emotions (including detecting and determining negative reactions versus positive reactions). Thus, for example, by accessing and leveraging the camera, sensors, speaker and microphone associated with a computing device, the virtual presentation assistance program 160 may detect whether a participant of the target audience, and/or a virtual avatar associated with the participant, is viewing the presenter during the presentation (for example, by using a camera to detect eye movement and/or tracking an avatar looking at or away from the presenter), detect certain movements or gestures (such as stretching, fiddling, typing, etc.), detect facial expressions (such as yawning, sleeping, emoting boredom, emoting dislike, emoting happiness, etc.), and detect other actions that may further include detecting whether a participant of the target audience is conversing with another participant during the presentation, detecting that the participant is accessing and using another app or application on the participant's computer during the presentation, and/or detect that an application is open on a display associated with the computing device such that a view of the presenter and/or the virtual environment in general is obstructed by a window associated with the application.

Additionally, for the participants identified as the target audience, the virtual presentation assistance program 160 may detect, track, and correlate the level of sound and the level of attention based on different sections of the target audience. Specifically, according to one embodiment, the virtual presentation assistance program 160 may crowdsource the level of sound and the level of attention for a given section of the target audience based on the level of sound and the level of attention individually detected for participants in the target audience. More specifically, according to one embodiment, the virtual presentation assistance program 160 may crowdsource the level of sound and the level of attention for a given section of the target audience by obtaining and aggregating information and real-time feedback that includes the level of sound and the level of attention from a group of participants. According to one embodiment, the virtual presentation assistance program 160 may automatically divide the target audience into section by diving the target audience into groups of participants whereby each of a section 1 to a section N may include two or more participants representing a group and section of the target audience. Furthermore, a section may be dynamic, and/or everchanging in real-time, such that the virtual presentation assistance program 160 may continuously generate and/or group as well as regroup/reorganize participants of the target audience differently over a course of a presentation. Based on this tracking, aggregating, and grouping/regrouping of participants, and as will be further described later, the virtual presentation assistance program 160 may continuously and dynamically identify different sections and groups of participants having a majority of positive or negative real-time feedback with regard to the presenter, the presenter's presentation, and or parts of the presenter's presentation.

Additionally, based on detecting one or more participants of the target audience being unable to hear a part of the presentation and/or not paying attention to parts of the presentation as described above, the virtual presentation assistance program 160 may be triggered to record and/or analyze speech from a certain amount of elapsed time (past, present, and future) of the presentation for re-presenting, and/or generating real-time feedback to the presenter to re-present or reiterate, a certain part of the presentation and/or a certain topic. More specifically, the virtual presentation assistance program 160 may include speech-to-text algorithms to generate text transcripts from each participant (including the presenter and the target audience) and associate a participant's userid (based on log-in information) with the participant's own transcript for analysis. In turn, the virtual presentation assistance program 160 may do a word-by-word comparison to detect differences in the transcript of the presenter compared to the transcripts of each participant of the target audience. Through such analysis, the virtual presentation assistance program 160 may determine exactly which users may not have heard certain words either because the audio from the presenter was inaudible or because of interruptions or side conversations from nearby participants. The virtual presentation assistance program 160 may also be able to indicate back to the presenter percentages of various topics that may have not reached sections of the target audience.

For example, in response to detecting the participant (P5) stating, “I can't hear the presenter from over here,” the virtual presentation assistance program 160 may be configured (via a user interface) such that the virtual presentation assistance program 160 may analyze speech from the presenter at a time before the participant's (P5) statement as well as analyze speech at a time after detecting the participant's (P5) statement. For example, in response to detecting the participant (P5) stating, “I can't hear the presenter from over here,” the virtual presentation assistance program 160 may be configured such that the virtual presentation assistance program 160 may analyze speech over a 20 min elapsed time whereby the elapsed time may be divided such that the virtual presentation assistance program 160 records/analyzes the speech from the presenter from 10 mins before detecting the participant's (P5) statement as well as record and/or analyzes the speech from 10 mins after detecting the participant's (P5) statement. Furthermore, the virtual presentation assistance program 160 may analyze the speech by using natural language processing techniques to, for example, perform topic analysis, topic recognition, semantic analysis, entity recognition, and other natural language processing techniques to identify topics and other coverage associated with the speech.

Similar to the detecting and tracking done specifically for participants of the target audience in the virtual event, the virtual presentation assistance program 160 may automatically detect and track one or more user actions and user reactions associated with presenters by, on the other hand, detecting and correlating a presenter's level of sound, movement, and gestures with regard to the target audience. Again, as previously described, common challenges/questions from the presenter side may include factors such as: can the audience at the back of the virtual environment see the presenter, can the audience hear the presenter well, can the audience see the presenter's hand gestures, is the presenter paying enough attention and giving eye contact to certain members and sections of the audience on different sides of the room. Accordingly, the virtual presentation assistance program 160 may automatically detect and track one or more user actions and user reactions associated with presenters based on such factors. More particularly, for the participants identified as presenters, the virtual presentation assistance program 160 may track and correlate a level of sound projected by a presenter based on the computing device (computer, mobile device, VR headset, and/or other ways the participant is accessing the virtual event) and the virtual avatar corresponding to the presenter to determine, for example, whether the presenter's microphone volume may be low and/or at a level below an acceptable or threshold level of sound quality. According to one embodiment, the virtual presentation assistance program 160 may determine the level of sound by, for example, accessing and leveraging the sensors, speakers and microphones associated with the computer of the presenter to similarly determine whether there are any disruptions/distortions in sound and/or other noise factors (such as noise coming from individuals other than the presenter into the presenter's microphone) that may be causing the participants of the target audience to not hear the presentation and/or certain parts of the presentation.

Also, as previously described, the virtual presentation assistance program 160 may track the level of sound associated with the presenter that may be received by a participant of the target audience based on a position of the presenter. Thus, again, the virtual presentation assistance program 160 may again use the sensors, speakers and/or microphone associated with the presenter, as well as the virtual environment 200 itself (i.e. positions of participants and objects in a virtual space of the virtual environment 200) to continuously and dynamically measure and correlate the amplitude and/or decibel units associated with the level of sound projected from the presenter based on a recorded position of the presenter. For example, according to one embodiment, the virtual presentation assistance program 160 may detect the participant (P5) stating. “I can't hear the presenter from over here,” when the presenter is positioned in a specific part of the virtual space. This may indicate to the virtual presentation assistance program 160 that the detected position of the presenter is hindering the level of sound received by certain participants of the target audience, and/or based on the position of the presenter, that the presenter may be speaking at a below threshold volume (measured by the decibel units) or that the presenter's microphone may be at a below threshold volume. Furthermore, having difficulty hearing the presenter and/or a part of the presentation and may, in turn, trigger the virtual presentation assistance program 160 to detect and record a position of the presenter in the virtual space as well as measure the decibel units of sound projected from the presenter and received by the participant of the target audience based on the recorded position of the presenter.

Furthermore, based on the presenter, the virtual presentation assistance program 160 may track a level of attention associated with a participant of the target audience relative to the presenter to determine, for example, whether the presenter is paying enough attention to the participants of the target audience during a presentation and/or part of a presentation of the presenter. As previously described, the virtual presentation assistance program 160 may track a level of attention based on detected user actions and user reactions that may include detected gestures, movements, and facial expressions of a user/avatar. As previously described, the virtual presentation assistance program 160 may access a user's/participant's computing device (again, such as a computer including a mobile phone, VR headset/goggles, PC, and other computing devices used to access the virtual event) and the computing device may further include a camera, sensors, speaker and microphone. Furthermore, according to one embodiment, the virtual presentation assistance program 160 may include natural language processing algorithms, machine learning algorithms, facial recognition software, key tracking software, haptic feedback tracking, motion/gesture tracking, and other algorithms and software to further detect movement, gestures, speech and emotions (including detecting and determining negative reactions versus positive reactions). Thus, for example, by accessing and leveraging the camera, sensors, speaker and microphone associated with a computing device, the virtual presentation assistance program 160 may detect whether a participant of the target audience, and/or a virtual avatar associated with the participant, is able to hear and/or view the presenter during the presentation, as well as detect a position and certain movements or gestures made by the presenter. In turn, the virtual presentation assistance program 160 may correlate the detected level of attention of participants in the target audience with the position, movement, and gestures associated with the presenter. For example, the virtual presentation assistance program 160 may detect that a participant of the target audience is not paying attention to the presenter based, for example, on detected eye contact associated with the participant. The virtual presentation assistance program 160 may also detect that during the participant's lack of eye contact with the presenter, the position of the presenter 202 is on the opposite side of the position of the participant in the virtual space associated with virtual environment 200. Accordingly, using one or more integrated machine learning algorithms and techniques, the virtual presentation assistance program 160 may determine a correlation between the presenter's position and the participant's lack of eye contact with the presenter. Therefore, the virtual presentation assistance program 160 may identify the correlation between the position of the presenter and the participant's lack of eye contact as real-time participant feedback.

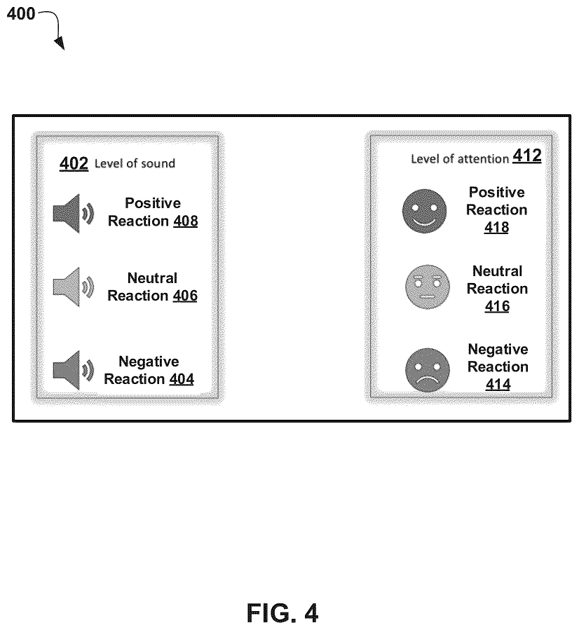

Next, at 306, the virtual presentation assistance program 160 may automatically generate and display to the presenter a real-time assessment of the virtual event based on the determined correlation and the real-time participant feedback associated with the target audience, whereby the real-time assessment further includes generating and displaying on the virtual environment visual prompts representing scaled user reactions from the target audience and generating and displaying suggestions for improving the scaled user reactions. Specifically, and as will be described with respect to FIGS. 4-6, the virtual presentation assistance program 160 may automatically generate and display the real-time assessment by first generating visual prompts which may, for example, include graphical user interface (GUI) icons for displaying and overlaying on the virtual environment and over participants of the target audience. More specifically, and as described in FIG. 4, the virtual presentation assistance program 160 may generate visual prompts that may include GUI icons 400 for representing the level of sound 402 and the level of attention 412 associated with participants and/or groups of participants of the target audience. As depicted in FIG. 4, a sound GUI icon 402 may represent the level of sound associated with participants of the target audience and a face GUI icon 416 may represent the level of attention. Additionally, the GUI icons 402, 412 may correspond to a value indicating a scale/range of the level of sound and the level of attention, respectively, to represent the scale/range of the user reactions (i.e. the scaled user reactions, which may range from a positive reaction to a negative reaction). Specifically, according to one embodiment, the virtual presentation assistance program 160 may use and integrate a heat map with the GUI icons 402, 412, whereby the virtual presentation assistance program 160 may adjust/change a color associated with the GUI icons 402, 412 based on a range of colors of the heat map corresponding to user experience associated with the target audience. More specifically, each color from the range of colors may be associated with a value indicating a type of user reaction, whereby the type of user reaction ranges from a positive reaction to a negative reaction based on the detected and tracked real-time participant feedback associated with participants of the target audience.

Thus, according to one embodiment, the heat map may be a data visualization technique used to represent data graphically where values are depicted by color. Accordingly, the virtual presentation assistance program 160 may determine and assign values to the level of sound and the level of attention associated with participants of the target audience based on the detected and tracked user actions and user reactions corresponding to the real-time participant feedback at step 304. In turn, the virtual presentation assistance program 160 may graphically represent the real-time participant feedback by depicting the determined and assigned values associated with the level of sound and the level of attention by color using the GUI icons 402, 412, respectively. For example, and according to one embodiment, the virtual presentation assistance program 160 may determine and assign a value to each of the level of sound and the level of attention, respectively, based on a scale/range of numbers such as a scale of 1 to 10, where “1” may indicate a negative reaction, “5” may indicate a medium/neutral reaction, and “10” may indicate a positive reaction. Accordingly, the heat map may include a spectrum of colors, whereby the spectrum of colors may correspond to a value from the range of values 1 to 10, such that: colors that include hues of “red” may correspond to lower values ranging between 1 and 3 (where a bright red may correspond to “1”) to represent more negative reactions or negative sections of participants in the target audience, color that include hues of “green” may correspond to higher values ranging between 7 and 10 (where a bright green may correspond to “10”) to represent more positive reactions and positive sections of the participants in the target audience, and colors that include hues of yellow may correspond to values between 4 and 6 (where a bright yellow may correspond to “5”) to represent medium/neutral reactions. Thus, for example, a “red” sound GUI icon 404 (color not shown) may correspond to a negative reaction based on the level of sound, a “yellow” sound GUI icon 406 (color not shown) may correspond to a neutral reaction based on the level of sound, and a “green” sound GUI icon 408 (color not shown) may correspond to a positive reaction based on the level of sound. Likewise, a “red” sad face GUI icon 414 (color not shown) may correspond to a negative reaction based on the level of attention, a “yellow” neutral face GUI icon 416 (color not shown) may correspond to a neutral reaction based on the level of attention, and a “green” happy face GUI icon 418 (color not shown) may correspond to a positive reaction based on the level of attention.

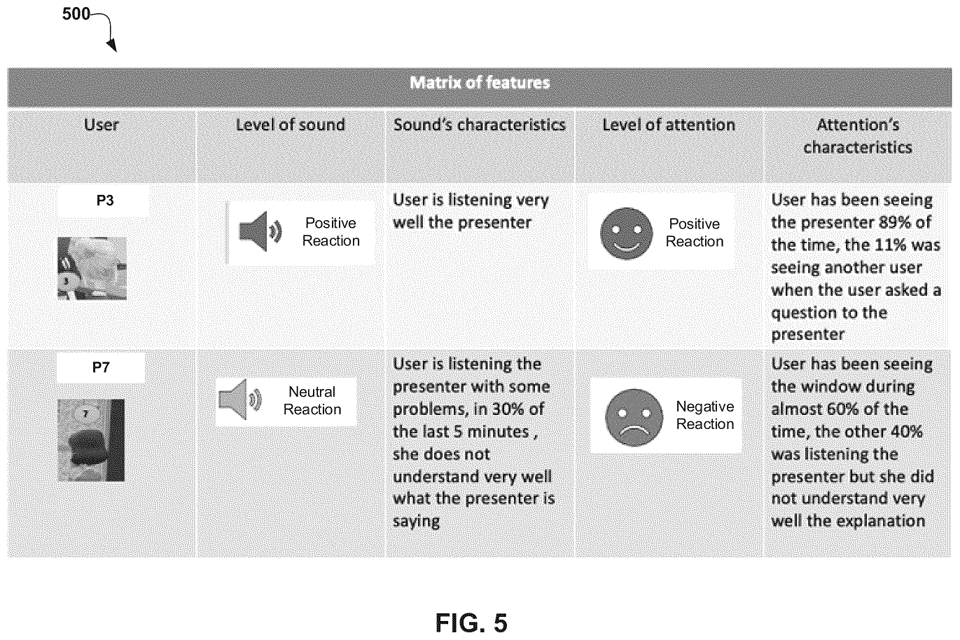

Accordingly, based on the scale of values ranging from 1 to 10 which correspond to a spectrum of colors of the heat map (red, yellow, and green), the virtual presentation assistance program 160 may initially and separately assign a medium value of 5 to each of the level of sound and the level of attention for all participants of the target audience upon launch of the virtual environment 200 and/or at log-in by a given participant that is identified as part of the target audience. Thereafter, based on certain detected user actions and user reactions described at step 304, the virtual presentation assistance program 160 may incrementally increase or decrease the value associated with the level of sound and/or the value associated the level of attention for a given participant as well as for a group of participants. For example, as previously described at step 304 and further depicted in participant feedback chart 500 in FIG. 5, based on the virtual presentation assistance program 160 detecting a participant of the target audience giving consistent eye contact to the presenter (or tracking that the participant is looking at the presenter over a threshold amount of time, such as 89%), the virtual presentation assistance program 160 may correspondingly and incrementally increase the value of the level of sound, as well as increase the value associated with the level of attention, to indicate positive reactions to both the level of sound and the level of attention. Conversely, based on the virtual presentation assistance program 160 detecting a participant of the target audience not being able to consistently understand or hear the presenter (which may be based on statements from the participant and or distortion from incoming sound as described above), and detecting the participant viewing windows of other applications over a period of time, the virtual presentation assistance program 160 may correspondingly and incrementally decrease the value of the level of sound and decrease the value associated with the level of attention to indicate a negative reaction to both the level of sound and the level of attention.

As previously described, the virtual presentation assistance program 160 may also crowdsource the level of sound and the level of attention for a given section of the target audience by obtaining and aggregating information and real-time feedback that includes the level of sound and the level of attention from a group of participants. Specifically, and as previously described, the virtual presentation assistance program 160 may automatically divide the target audience into sections by diving the target audience into groups of participants whereby each of a section 1 to a section N may include two or more participants representing a group and section of the target audience. Furthermore, a section may be dynamic, and/or everchanging in real-time, such that the virtual presentation assistance program 160 may continuously generate and/or group as well as regroup/reorganize participants of the target audience differently over a course of a presentation. Based on this tracking, aggregating, and grouping/regrouping of participants, the virtual presentation assistance program 160 may continuously and dynamically identify different sections and groups of participants having a majority of positive or negative real-time feedback with regard to the presenter, the presenter's presentation, and or parts of the presenter's presentation. Accordingly, based on the scale of values ranging from 1 to 10 and the corresponding spectrum of colors, the virtual presentation assistance program 160 may initially and separately assign a medium value of 5 to the level of sound and to the level of attention for a section or group of participants of the target audience upon launch of the virtual environment 200 and/or log-in by given participants that are identified as part of the target audience. Thereafter, based on certain detected user actions and user reactions described at step 304, the virtual presentation assistance program 160 may incrementally increase or decrease an aggregated value associated with the level of sound and/or an aggregated value associated the level of attention for a given section/group of participants, whereby the aggregated values for a given section/group may be based on an aggregation of individual values associated with the level of sound and the level of attention for each participant in the section/group.

According to one embodiment, the virtual presentation assistance program 160 may also weigh different types of user actions and user reactions detected at step 304 differently. As previously described, the virtual presentation assistance program 160 may detect different user actions and reactions associated with a participant of a virtual event that may include detecting whether a participant of the target audience is viewing the present, whether a participant of the target audience can hear the presenter, whether a conversation and/or other ambient sound is distorting a participant's level of sound, whether a participant makes statements regarding the virtual event (for example, regarding the presentation and/or the presenter), facial expressions associated with participants, etc. Accordingly, the virtual presentation assistance program 160 may be configured (via a user interface) to weigh, for example, participant statements regarding the presentation and/or the presenter over determining whether a participant is viewing the presenter. According to one embodiment, assigning more weight to a first type of user action/reaction over second type of user action/reaction may include placing a greater value on the first type user action/reaction such that the virtual presentation assistance program 160 may incrementally increase or decrease the value of the level of sound and/or the level of attention by a greater amount (as well as change the corresponding color) in response to detecting the first type of user action/reaction than when detecting the second type of user action/reaction.

Furthermore, according to one embodiment, the virtual presentation assistance program 160 may also weigh different types of user actions and user reactions detected at step 304 differently according to a type of participant and/or credentials associated with a participant. For example, and as previously described, the virtual presentation assistance program 160 may allow a user to identify certain key audience members of a target audience either during a registration process, before entering/launching the virtual event, at log-in into the virtual environment/event, and/or during the virtual event. For example, because of a certain importance, a user/presenter may consider a boss a key audience member and/or may consider other colleagues/friends that are important or have a certain expertise related to a discussion that the user may be presenting in the virtual event as key audience members. As such, according to one embodiment, the virtual presentation assistance program 160 may present the user with a user interface whereby a user may select individuals as key audience members during a registration process, before entering/launching the virtual event, at log-in into the virtual environment/event, and/or during the virtual event. Based on the selection, the virtual presentation assistance program 160 may weigh user actions and reactions from detected key audience members more than other participants from the target audience. For example, the virtual presentation assistance program 160 may identify a particular participant as a key audience member based on a title or position linked to the participant's log-in information or userid. Thus, for example, the virtual presentation assistance program 160 may additionally use this as additional weight in marking topics that the presenter may want to re-emphasize. For example, the presenter is pitching to a chief executive officer (CEO) of a company or other decision maker for a product. The virtual presentation assistance program 160 may detect that the CEO missed an important feature of the product because at the time the presenter mentioned the feature because a nearby participant asked the CEO “how do you like the presentation so far?” As such, the virtual presentation assistance program 160 may weigh this feedback received from the CEO more than other participants of the target audience which may also trigger the virtual presentation assistance program 160 to directly show (on the virtual environment via a virtual display) this feedback from the CEO and prompt the presenter to re-emphasize that important feature to make sure the feature did not get missed by a key person in the audience.

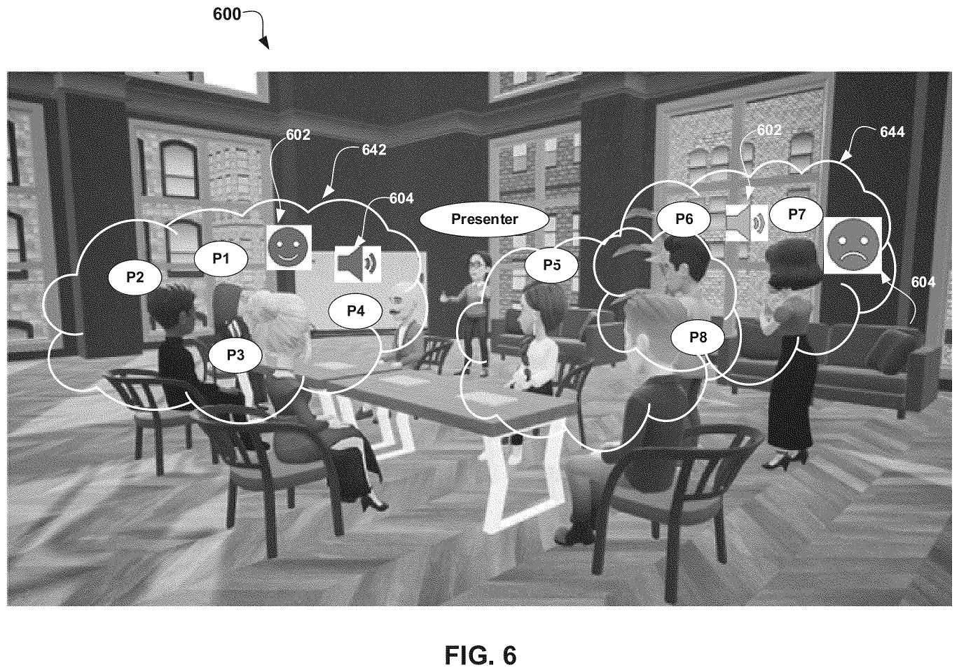

As previously described, the virtual presentation assistance program 160 may automatically generate and display the real-time assessment by first generating visual prompts which may, for example, include the graphical user interface (GUI) icons 402, 412. Thereafter, the virtual presentation assistance program 160 may display the real-time assessment by, for example, displaying and overlaying on the virtual environment and over participants of the target audience the visual prompts. For example, and as depicted in FIG. 6, the virtual presentation assistance program 160 may display the real-time assessment by displaying and overlaying, on the virtual environment 600 and over participants of the target audience, the visual prompts that may include the GUI icons 602, 604 (previously described in FIG. 4) as well as other visual prompts (including circular icons 642, 644 to identify different sections the target audience) to indicate whether a participant or sections of participants in the target audience are experiencing positive reactions or negative reactions based on the level of sound and the level of attention, respectively. For example, based on detected and aggregated user actions and user reactions associated with a section 642 of participants in the target audience, the virtual presentation assistance program 160 may detect positive reactions associated with both the level of sound and the level of attention for the section 644, and may indicate the positive reactions by a color “green” (not shown) for the GUI icons 602, 604 as well as the circular icon 642 in the section 642. Conversely, based on detected and aggregated user actions and user reactions associated with a section 644 of participants in the target audience, the virtual presentation assistance program 160 may detect negative reactions associated with both the level of sound and the level of attention for the section 644, and may indicate the negative reactions by a color “red” (not shown) for the GUI icons 602, 604 in and the circular icon 644.

According to one embodiment, in addition to the visual prompts including the GUI icons 602, 604, as well as the circular icons 642, 644, the virtual presentation assistance program 160 may also display visual prompts in the form of text, whereby the text may include suggestions for the presenter to improve reactions and experiences associated with participants in the target audience. For example, in response to detecting the negative reactions associated with the level of sound and level of attention for the section 644, as well as determining a correlation between the negative reactions and the presenter's position in virtual environment 600 (such as by determining that the presenter has not been looking in the direction of the section 644 over a period of time), the virtual presentation assistance program 160 may generate and display a visual prompt over the section 644 that includes a pop-up window with text, such as “Look Here”, to indicate to the presenter to pay more attention to section 644. Also, for example, in the case where the presenter is pitching to a CEO of a company or other decision maker for a product, the virtual presentation assistance program 160 may detect that the CEO missed an important feature of the product because at the time the presenter mentioned the feature because a nearby participant asked the CEO “how do you like the presentation so far?” As such, the virtual presentation assistance program 160 may present this feedback on the virtual environment 600 and/or display a visual prompt to the presenter that includes a pop-up window with text such as, “Re-emphasize feature X”, to make sure the feature did not get missed by a key person in the audience. As such, the virtual presentation assistance program 160 may automatically generate and display to the presenter a real-time assessment of the virtual event based on the determined correlation and the real-time participant feedback associated with the target audience, whereby the real-time assessment further includes generating and displaying on the virtual environment visual prompts representing scaled user reactions from the target audience and generating and displaying suggestions for improving the scaled user reactions.

It may be appreciated that FIGS. 2-6 provide only illustrations of one implementation and does not imply any limitations with regard to how different embodiments may be implemented. Many modifications to the depicted environments may be made based on design and implementation requirements. For example, before a virtual event and/or a virtual environment is launched, or in response to launching a virtual event, the virtual presentation assistance program 160 may display to the presenter (via a user interface) previous and common feedback/requests for the virtual event, the virtual environment, and/or the presenter based on potential participants in the virtual event (whereby the potential participants may be detected based on participants confirming an attendance to the virtual event). For example, based on a venue size and/or participant capacity associated with a virtual environment, the virtual presentation assistance program 160 may detect, based on previous instances of the virtual environment as well as previous feedback from participants in the virtual environment, that a target audience usually tends to want the presenter to speak up due to the size of the venue. Therefore, the presenter may adjust a mic's volume to be at a higher default before the presenter's presentation starts. According to one embodiment, the virtual presentation assistance program 160 may also provide/display other feedback and statistics associated with potential participants in the virtual event and on the virtual environment to the presenter before and/or upon launch of the virtual environment based on previous feedback/statistics recorded and stored from previous virtual environments/events, such as topics of interest to certain participants, and previous level of sound and level of attention statistics. Furthermore, according to one embodiment, the virtual presentation assistance program 160 may enable a presenter to select prepopulated camera waypoints so that the presenter may have different viewpoints of the target audience and be able to view what the audience is seeing as the presenter presents. Additionally, the virtual presentation assistance program 160 may use the camera waypoints to measure arm movements and audio heard at the distance.

As previously described, the present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Furthermore, machine learning as described herein may broadly refer to machine learning algorithms that learn from data. More specifically, machine learning is a branch of artificial intelligence that relates to algorithms such as mathematical models that can learn from, categorize, and make predictions about data. Such mathematical models, which can be referred to as machine-learning models, can classify input data among two or more classes; cluster input data among two or more groups; predict a result based on input data; identify patterns or trends in input data; identify a distribution of input data in a space; or any combination of these. Examples of machine-learning models can include (i) neural networks; (ii) decision trees, such as classification trees and regression trees; (iii) classifiers, such as Naïve bias classifiers, logistic regression classifiers, ridge regression classifiers, random forest classifiers, least absolute shrinkage and selector (LASSO) classifiers, and support vector machines; (iv) clusters, such as k-means clusters, mean-shift clusters, and spectral clusters; (v) factorization machines, principal component analyzers and kernel principal component analyzers; and (vi) ensembles or other combinations of machine-learning models. Neural networks can include deep neural networks, feed-forward neural networks, recurrent neural networks, convolutional neural networks, radial basis function (RBF) neural networks, echo state neural networks, long short-term memory neural networks, bi-directional recurrent neural networks, gated neural networks, hierarchical recurrent neural networks, stochastic neural networks, modular neural networks, spiking neural networks, dynamic neural networks, cascading neural networks, neuro-fuzzy neural networks, or any combination of these.

What is claimed is:

1. A computer-implemented method for automatically generating and displaying real-time virtual feedback to a presenter in a virtual environment corresponding to a user experience associated with a target audience in the virtual environment, comprising:
in response to initiating and detecting a virtual event, automatically identifying one or more participants in the virtual environment associated with the virtual event, wherein identifying the one or more participants further comprises identifying the presenter and the target audience;
automatically detecting and tracking one or more user actions and user reactions associated with each of the one or more participants in the virtual event to identify real-time participant feedback associated with each of the one or more participants based on the virtual event, wherein identifying the real-time participant feedback further comprises determining a correlation between the real-time participant feedback associated with the one or more participants of the target audience with the real-time participant feedback associated with the presenter; and
automatically generating and displaying to the presenter a real-time assessment of the virtual event based on the determined correlation and the real-time participant feedback associated with the target audience, wherein the real-time assessment further includes generating and displaying on the virtual environment visual prompts representing scaled user reactions from the target audience and generating and displaying suggestions for improving the scaled user reactions.

2. The computer-implemented method of claim 1, wherein automatically identifying the one or more participants in the virtual environment further comprises:
automatically detecting and accessing user profile data associated with the participants.

3. The computer-implemented method of claim 1, wherein automatically identifying the one or more participants in the virtual environment further comprises,
automatically identifying whether the participants in the virtual environment are key audience members.

4. The computer-implemented method of claim 1, wherein automatically detecting and tracking the one or more user actions and the user reactions further comprises:
automatically detecting and tracking the one or more user actions and the user reactions associated with each of the participants based on movements and communications detected using a computer and virtual avatars of each of the one or more participants to determine the correlation, whereby determining the correlation further comprises detecting and tracking the one or more user actions and the user reactions based on a presentation made by the presenter in the virtual event.

5. The computer-implemented method of claim 1, wherein automatically detecting and tracking the one or more user actions and the user reactions further comprises:
detecting and tracking the one or more user actions and the user reactions differently for the one or more participants based on whether a participant is the presenter or the target audience.

6. The computer-implemented method of claim 1, automatically generating and displaying to the presenter the real-time assessment further comprises:
automatically generating and displaying the real-time assessment by generating the visual prompts including graphical user interface (GUI) icons for displaying and overlaying on the virtual environment and over the one or more participants of the target audience.

7. The computer-implemented method of claim 6, further comprising:
automatically using and integrating a heat map with the GUI icons, and automatically adjusting a color associated with the GUI icons based on a range of colors of the heat map corresponding to the user experience associated with the target audience.

8. A computer system for automatically generating and displaying real-time virtual feedback to a presenter in a virtual environment corresponding to a user experience associated with a target audience in the virtual environment, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
in response to initiating and detecting a virtual event, automatically identifying one or more participants in the virtual environment associated with the virtual event, wherein identifying the participants further comprises identifying the presenter and the target audience;
automatically detecting and tracking one or more user actions and user reactions associated with each of the one or more participants in the virtual event to identify real-time participant feedback associated with each of the one or more participants based on the virtual event, wherein identifying the real-time participant feedback further comprises determining a correlation between the real-time participant feedback associated with the one or more participants of the target audience with the real-time participant feedback associated with the presenter; and
automatically generating and displaying to the presenter a real-time assessment of the virtual event based on the determined correlation and the real-time participant feedback associated with the target audience, wherein the real-time assessment further includes generating and displaying on the virtual environment visual prompts representing scaled user reactions from the target audience and generating and displaying suggestions for improving the scaled user reactions.

9. The computer system of claim 8, wherein automatically identifying the one or more participants in the virtual environment further comprises:
automatically detecting and accessing user profile data associated with the participants.

10. The computer system of claim 8, wherein automatically identifying the one or more participants in the virtual environment further comprises,
automatically identifying whether the participants in the virtual environment are key audience members.

11. The computer system of claim 8, wherein automatically detecting and tracking the one or more user actions and the user reactions further comprises:
automatically detecting and tracking the one or more user actions and the user reactions associated with each of the one or more participants based on movements and communications detected using a computer and virtual avatars of each of the one or more participants to determine the correlation, whereby determining the correlation further comprises detecting and tracking the one or more user actions and the user reactions based on a presentation made by the presenter in the virtual event.

12. The computer system of claim 8, wherein automatically detecting and tracking the one or more user actions and the user reactions further comprises:
detecting and tracking the one or more user actions and the user reactions differently for the one or more participants based on whether a participant is the presenter or the target audience.

13. The computer system of claim 8, automatically generating and displaying to the presenter the real-time assessment further comprises:
automatically generating and displaying the real-time assessment by generating the visual prompts including graphical user interface (GUI) icons for displaying and overlaying on the virtual environment and over the one or more participants of the target audience.

14. The computer system of claim 13, further comprising:
automatically using and integrating a heat map with the GUI icons, and automatically adjusting a color associated with the GUI icons based on a range of colors of the heat map corresponding to the user experience associated with the target audience.

15. A computer program product for automatically generating and displaying real-time virtual feedback to a presenter in a virtual environment corresponding to a user experience associated with a target audience in the virtual environment, comprising:
one or more tangible computer-readable storage devices and program instructions stored on at least one of the one or more tangible computer-readable storage devices, the program instructions executable by a processor, the program instructions comprising:
in response to initiating and detecting a virtual event, automatically identifying one or more participants in the virtual environment associated with the virtual event, wherein identifying the one or more participants further comprises identifying the presenter and the target audience;
automatically detecting and tracking one or more user actions and user reactions associated with each of the one or more participants in the virtual event to identify real-time participant feedback associated with each of the one or more participants based on the virtual event, wherein identifying the real-time participant feedback further comprises determining a correlation between the real-time participant feedback associated with the one or more participants of the target audience with the real-time participant feedback associated with the presenter; and
automatically generating and displaying to the presenter a real-time assessment of the virtual event based on the determined correlation and the real-time participant feedback associated with the target audience, wherein the real-time assessment further includes generating and displaying on the virtual environment visual prompts representing scaled user reactions from the target audience and generating and displaying suggestions for improving the scaled user reactions.

16. The computer program product of claim 15, wherein automatically identifying the one or more participants in the virtual environment further comprises:
automatically detecting and accessing user profile data associated with the one or more participants.

17. The computer program product of claim 15, wherein automatically identifying the one or more participants in the virtual environment further comprises,
automatically identifying whether the one or more participants in the virtual environment are key audience members.

18. The computer program product of claim 15, wherein automatically detecting and tracking the one or more user actions and the user reactions further comprises:
automatically detecting and tracking the one or more user actions and the user reactions associated with each of the participants based on movements and communications detected using a computer and virtual avatars of each of the one or more participants to determine the correlation, whereby determining the correlation further comprises detecting and tracking the one or more user actions and the user reactions based on a presentation made by the presenter in the virtual event.

19. The computer program product of claim 15, wherein automatically detecting and tracking the one or more user actions and the user reactions further comprises:
detecting and tracking the one or more user actions and the user reactions differently for the one or more participants based on whether a participant is the presenter or the target audience.

20. The computer program product of claim 15, automatically generating and displaying to the presenter the real-time assessment further comprises:
automatically generating and displaying the real-time assessment by generating the visual prompts including graphical user interface (GUI) icons for displaying and overlaying on the virtual environment and over the one or more participants of the target audience.
